(19) United States
(12) Patent Application Publication
(10) Pub. No.: US 2018/0354083 A1
(43) Pub. Date: Dec. 13, 2018

(54) Manufacturing Device And Manufacturing Method

(71) Applicant: KUKA Systems GmbH, Augsburg (DE)

(72) Inventor: Paul Thorwarth, Augsburg (DE)

(21) Appl. No.: 15/779,379

(22) PCT Filed: Nov. 17, 2016
(86) PCT No.: PCT/EP2016/078012

§ 371 Date: May 25, 2018

(30) Foreign Application Priority Data
Nov. 27, 2015 (DE) 20 2015 106 459.4

(51) Int. Cl. B23P 21/00; B62D 65/02; B62D 65/18

(52) U.S. Cl. CPC B23P 21/004; B23P 2700/50; B62D 65/18; B62D 65/022

(57) ABSTRACT

An automatic manufacturing device and a manufacturing method for workpieces, in particular for bodywork components, which has at least one program-controlled manufacturing means and a working point. Arranged in the manufacturing device is a conveying path for a conveying means having a load-receiving means for a workpiece and/or for a tool. The path extends through the manufacturing device and through the working point, wherein, at the working point, a storage carrier for a workpiece is arranged at a vertical distance from the conveying path.

### CROSS-REFERENCE

This application is a national phase application under 35 U.S.C. § 371 of International Patent Application No. PCT/EP2016/078012, filed Nov. 17, 2016 (pending), which claims the benefit of German Patent Application No. DE 10 2015 106 459.4 filed Nov. 27, 2015, the disclosures of which are incorporated by reference herein in their entirety.

### TECHNICAL FIELD

The invention relates to an automatic manufacturing device and a manufacturing method with the features in the preamble of the method and device main claim.

### BACKGROUND

Such a manufacturing device is known from DE 20 2014 101 002 U1. The manufacturing device comprises two manufacturing cells, each having a working point and a local stationary receiving device for workpieces. A transport logistics system, which comprises handling robots on driving axles and end-side interfaces for a workpiece change and serves the working points and delivers and removes workpieces, is disposed on the external face of the manufacturing device facing toward a passing conveying path.

### SUMMARY

The object of the present invention is to identify a further improved automatic manufacturing technology.

The invention achieves these objects with the features in the exemplary method and device shown and described herein. The claimed manufacturing technology, i.e. a manufacturing device, a manufacturing method and a manufacturing system, has a variety of advantages.

On the conveying path leading through the automatic manufacturing device and through the working point, conveying means can deliver workpieces and/or tools to the working point and remove them again, or even transport said workpieces and/or tools through the manufacturing device. This allows the manufacturing device to be incorporated into a conveying device and a conveying line system of a manufacturing system. The continuous conveying path can be used to interlink multiple manufacturing devices.

The storage carrier, which is arranged at a vertical distance, in particular upwards, from the conveying path and from the conveying means, can form a temporary repository for a workpiece at the working point. One or more processes can be performed by program-controlled manufacturing means on a workpiece situated here. Multiple workpieces, which are delivered by one or more conveying means, can also be assembled on the storage carrier.

For this purpose, each conveying means has a permanently allocated or changeable load-receiving means for a workpiece and/or for a tool. If multiple workpieces are arranged on a load-receiving means, it is not yet necessary for them to be in a manufacturing-appropriate position. They can be packed more densely. Thanks to the storage carrier, the load-receiving means can be unloaded at the working point by a program-controlled manufacturing means, wherein the manufacturing-appropriate position and allocation of the different workpieces is not established until they are on the storage carrier.

The unloaded conveying means can then move out of the working point again and clear the conveying path. Other workpieces can subsequently be delivered by the same or a different conveying means. A finished workpiece can be removed by the same or a different conveying means. The cleared conveying path can also be used as a throughway for other loaded or empty conveying means. The spaced-apart storage carrier decouples the processes and the process-appropriate workpiece position from the conveying path.

The conveying path is preferably disposed close to the ground, in particular in a floor-bound manner. The conveying means traveling on the conveying path are also preferably floor-bound, and are preferably autonomous vehicles. The storage carrier is preferably disposed at a distance above the conveying path and the conveying means and frees a passage opening for an empty or loaded conveying means at the working point. A local support device provided for the storage carrier at the working point can be configured accordingly and likewise leave the passage opening free.

The storage carrier can be configured to be mobile, and can be moved between a working position on the conveying path and a rest position a distance away from said working position by means of a handling device. In the rest position, the passage opening can be enlarged vertically and allow overheight loaded conveying means to pass through. Any workpiece on the storage carrier can be picked up and held by a program-controlled manufacturing device in the meantime.

At the working point, the manufacturing device can comprise a positioning device for a load-receiving means and/or for a conveying means. Said positioning device is preferably disposed on the support device and ensures a precise positioning of the workpieces for an unloading and a loading procedure. A process can alternatively or additionally also be performed on a workpiece situated on a load-receiving means at the working point.

The manufacturing device is preferably configured in an application-flexible manner and can perform a wide variety of processes on different workpieces, and if necessary also handle said workpieces, by means of program-controlled manufacturing means, in particular industrial robots. The manufacturing device can be adapted to the respective application and the respectively required process or processes with the aid of application-specific and exchangeable tools.

The tools can be stored in the manufacturing station by means of repositories and can be delivered and removed by conveying means with load-receiving means. A variety of application-specific control programs and other programs can furthermore be stored in a control of the manufacturing system. Said programs can be selected with the aid of a workpiece-specific and/or application-specific identifier on a load-receiving means. The respective required tooling of the manufacturing means can also be identified and set in this manner. A number of different processes can thus be performed in the manufacturing device on a number of different workpieces. Therefore, as a result of the variable tooling and program allocation, the manufacturing device is application flexible.

The manufacturing device can be connected with another manufacturing device for a secondary process on a workpiece. Processes can be performed here, for example, that are not, or only with difficulty, realizable in the application-flexible manufacturing device. Diversification and simultaneous performance of multiple processes can moreover save cycle time and increase production output. Workpiece change can be accomplished via interfaces on the periphery of the manufacturing devices. The interfaces can be located on a protective enclosure surrounding the respective manufacturing device. The interfaces on the conveying path can be configured as gates for empty and loaded conveying means in the protective enclosure.

There can be multiple manufacturing means and they can constitute the components of a manufacturing system. Said manufacturing system comprises a conveying device with multiple conveying means and with at least two load-receiving means of different types. The load-receiving means are adapted to different types of workpieces and provided with the aforementioned identifiers.

Multiple lined-up manufacturing devices can be directly connected to one another by means of a common, continuous conveying path. A conveying line can thus be formed. A conveying means can pass through multiple manufacturing devices on the conveying line, if necessary without interruption.

Another conveying path can be disposed adjacent to the lined-up manufacturing devices. Said conveying path can form another conveying line. With cross-connections, the conveying lines running through and adjacent to the manufacturing devices can form a conveyor line system network. They can make one-way traffic with a defined outward path and return path possible, which substantially facilitates and simplifies the transport logistics, and in particular the programming thereof, and minimizes malfunctions and accidents. An access corridor can be formed between spaced manufacturing devices, which, on the one hand, connects the conveying lines running through and adjacent to the manufacturing devices to one another and, on the other hand, also allows for a parking area or buffer area for loaded or empty conveying means. The conveying means can change their direction of travel at the access corridors. This is achieved with a controllable design of the conveying means, for example, or with the aid of repositioners, e.g. turntables or the like.

The conveying device connects a manufacturing area and a logistics area of a manufacturing system, wherein one or more manufacturing and conveying loops can be formed by the network of conveying lines. This facilitates and simplifies production planning in the manufacturing system and is also advantageous for unscrambling the conveyor tracks to be traversed by the conveying means within a production cycle. The conveying traffic can be controlled and monitored easily and more effectively. The traffic is also less confusing and facilitates the planning and operation of the manufacturing system.

Other advantageous embodiments of the invention are specified in the dependent claims.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the present invention.

FIG. 1 depicts a manufacturing area of an exemplary manufacturing system with multiple interlinked manufacturing devices,

FIG. 2 is a schematic representation of a manufacturing system with a manufacturing area, a logistics area and a conveying device,

FIGS. 3 to 5 depict different perspectives and operating positions of a working point having a storage carrier in a manufacturing device,

FIGS. 6 and 7 illustrate two functional sequences at working point and

FIG. 8 is a sectional detail view of a manufacturing area with multiple interlinked manufacturing devices and a logistics area.

### DETAILED DESCRIPTION

The invention relates to a manufacturing device (18-22) for workpieces (2, 2′, 2″) and the manufacturing processes occurring there. The invention further relates to a manufacturing system (1) with multiple manufacturing devices (18-22) and a manufacturing method for workpieces (2, 2′, 2″).

The manufacturing devices (18-22) as well as the manufacturing system (1) and the other components of said manufacturing system are automated and program-controlled.

The workpieces (2, 2′, 2″) can be of any kind and size. They can be one-piece or multi-part. The term “workpiece” also includes a plurality of workpieces. The workpieces (2, 2′, 2″) are preferably bodywork components of vehicle bodies. The manufacturing system (1) can, for example, be used for the body-in-white of vehicle bodies. The workpieces (2, 2′, 2″) can be configured in different ways.

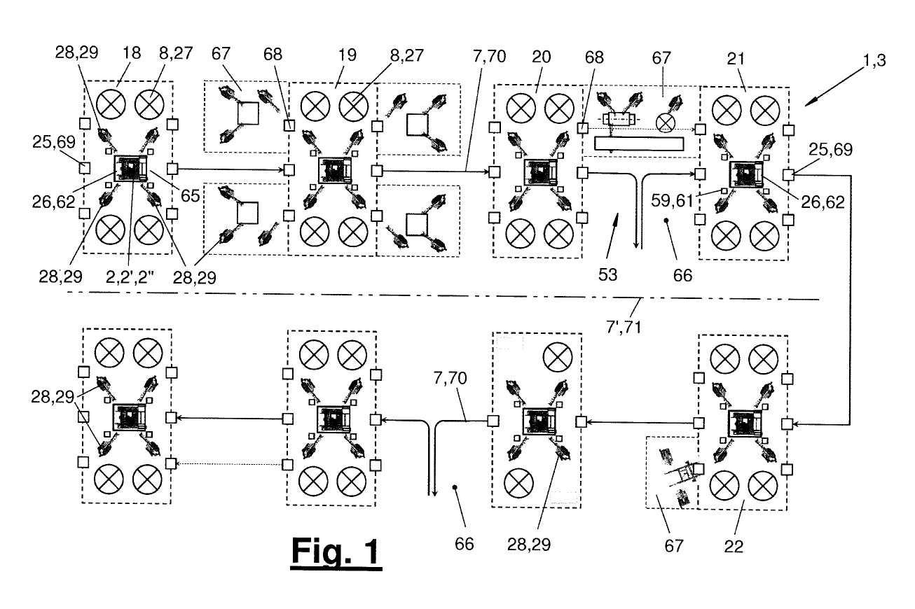

In the course of the automatic manufacturing method, one or more workpieces (2, 2′, 2″) can be processed with different manufacturing processes in a sequence of manufacturing steps as per FIGS. 1 to 4. The number of steps depends on the process volume, the capacity utilization, the timing requirements and other criteria. In doing so, e.g. in body-in-white construction, a manufacturing product, in particular a bodywork component, is produced by assembling and joining workpiece parts. It can be an intermediate product from which, with further processes, e.g. connection to other workpiece parts or otherwise manufactured intermediate products, an end product is produced. The manufacturing steps are preferably carried out in sequence one after the other multiple manufacturing devices (18-22). In doing so, one or more process segments are respectively carried out in each manufacturing step.

These manufacturing processes can relate to different techniques, e.g. joining, in particular welding, soldering or bonding, applying and removing materials, heat treatments, forming, machining, assembly and installation processes, etc.

The manufacturing system (1), the manufacturing method and the manufacturing devices (18-22) are flexible and application-specifically adaptable. The adaptation to different manufacturing processes and/or to different workpieces (2, 2′, 2″) is referred to as an application specification.

Different application-specific tools (8) are needed for these different processes. The application-specific tools (8) can be individual tools or sets of tools. They can consist of multiple tool segments. For the sake of simplicity, the application-specific tools (8) will be referred to as tools (8) in the following.

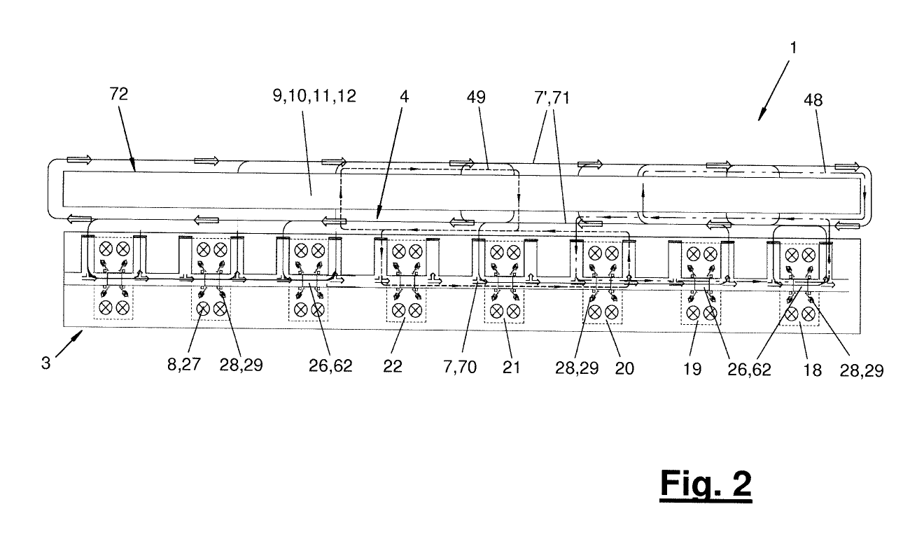

FIGS. 1 and 2 show a schematic representation of a manufacturing system (1) and its components. The manufacturing system (1) comprises a manufacturing area (3) with multiple manufacturing devices (18-22) disposed therein. The manufacturing system (1) further comprises a logistics area (72). Said logistics area can comprise a provision (10) for workpieces (2, 2′, 2″) and a provision (11) for different aforementioned tools (8). The provisions (10, 11) are also referred to as a warehouse (10) and a tool store (11).

There is also a conveying device (4), which flexibly connects and interlinks the manufacturing devices (18-22) with one another and with the preferably external logistics area (72).

The conveying device (4) can be configured in any suitable manner. In the embodiments shown, it comprises a plurality of conveying means (5) and a plurality of conveying paths (7, 7′) on which the conveying means (5) operate.

A conveying path (7) extends through a respective manufacturing device (18-22). Another conveying path (7′) respectively extends adjacent to a manufacturing device (18-22). The conveying paths (7, 7′) can be disposed parallel to one another.

Multiple continuous conveying paths (7) can connect to one other and together form a conveying line (70). Multiple adjacent conveying paths (7′) can connect to one other and together form a conveying line (71). The conveying lines (70, 71) can extend spaced apart from one another, in particular parallel. They can be cross-connected with one another, e.g. at the ends of the manufacturing area (3) and/or on an access corridor (66) between two manufacturing devices (18-22) spaced apart along the conveying path (7). The conveying paths (7, 7′) and the conveying lines (70, 71) are preferably arranged in a network and can also intersect.

The conveying means (5) can be individually controllable and are preferably autonomous. The conveying means (5) are preferably configured as floor-bound driverless transport vehicles, so-called AGV or FTF. They can navigate curves or possibly also turn on the spot. They may also be able to move omnidirectionally, for example by means of Mecanum wheels. The conveying means (5) can alternatively be disposed in a suspended manner and, for example, move on elevated conveyor rails with switches. They can furthermore be configured as roller or belt conveyors. The conveying device (4) can comprise multiple different conveying means (5).

The conveying means (5) travel within the network of conveying paths (7, 7′) and conveying lines (70, 71) on freely programmable conveyor tracks. The conveying lines (70, 71) are preferably configured as one-way streets with opposite directions of travel indicated by arrows. The cross-connections, in particular the access corridor or access corridors (66), can result in the formation of conveying loops (48, 49), which also create manufacturing loops when multiple manufacturing devices (18-22) are interlinked. The manufacturing or conveying loops (48, 49) can overlap one another.

At the one or more access corridors (66), the conveying means (5) can optionally move along the conveying path (7) or the conveying line (70) from one manufacturing device (18-22) into the next, or turn on the cross-connection and move to the other conveying line (71). Turning can take place via the conveying means' (5) own steering movement, via repositioning by means of a turntable or in some other way.

A parking area (53) for temporarily parking an empty or loaded conveying means (5) can be configured in the access corridor (66) or the cross-connection. Buffer stores for compensating cycle time differences or phases with malfunctions, or even for sequence recovery or other purposes, can thus be formed. The access corridor or access corridors (66) can be sealed off from a lateral conveying path (7′) or a lateral conveying line (71), and comprise a steerable and controllable through-passage (73) for an empty or loaded conveying means (5). Said through-passage can, for example, be configured as a safety gate with optical sensing and monitoring of the surroundings.

Each conveying means (5) in the various embodiments preferably has its own individually steerable drive and its own programmable control. Power can be supplied in any suitable manner, e.g. by means of a stationary or non-stationary power supply device.

To transport workpieces (2, 2′, 2″) and/or tools (8) from the logistics area (72) to the manufacturing area (3) and back, and in the manufacturing area (3) between the manufacturing devices (18-22), each conveying means (5) holds one or more adapted load-receiving means (6). These are referred to in the following with the abbreviation LAM.

The LAM (6) can be fixedly or interchangeably disposed on a conveying means (5). The LAM (6) can have a fixed adaptation for specific workpieces (2, 2′, 2″) and/or tools (8). They can alternatively be configured to be flexible or adjustable and variably adaptable. The LAM (6) can comprise different customized receptacles and holding means for the workpieces (2, 2′, 2″) and/or tools (8) and hold said receptacles and holding means in a defined position. As a base, the LAM (6) can have a plate or frame-shaped support, for example.

Multiple LAM (6) are configured in different ways and constitute different types (A, B, C, D). They can thus be adapted to different workpieces (2, 2′, 2″). An adjustable LAM (6) can constitute two or more different types. The number of different LAM types (A, B, C, D) can be as high as desired and is two, three, four or more. The number can be a function of the process volume to be produced in the manufacturing system (1), in particular a function of the number of different workpieces (2, 2′, 2″). Additional LAM types can be available for the tools (8).

The type-different LAM (6) have a type identifier for their respective type (A, B, C, D), which can be detected and recognized by a detection device on the manufacturing devices (18-22). The type identifier can be information and control technologically associated with a specific workpiece (2, 2′, 2″) and can represent the type of the workpiece (2, 2′, 2″) and/or tool (8).

The manufacturing system (1) comprises a provision (9) for the various LAM (6), which is connected with the conveying device (4) and preferably integrated into the logistics area (72). Such a provision (9, 10, 11) can, for example, comprise a storage area for workpieces (2, 2′, 2″) and/or tools (8) and/or LAM (6) and a loading area with a loading device connected to the conveying device (4). The manufacturing system (1) further comprises a provision (12) for conveying means (5).

In the manufacturing area (3), the multiple manufacturing devices (18-22) are arranged in a linear or two-dimensional distribution. The manufacturing devices (18-22) are preferably arranged in a uniform, in particular Cartesian, matrix. The conveying device (4) is designed to move at least one type, in particular all types (A, B, C, D), of LAM (6) on the conveying paths (7, 7′) and the conveying lines (70, 71) to and from the manufacturing device or manufacturing devices (18-22).

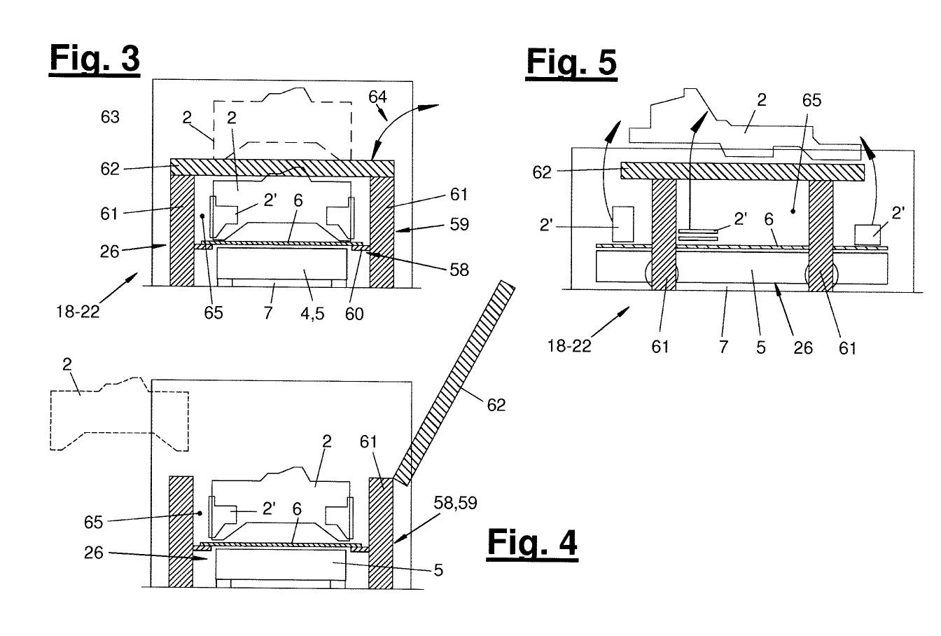

At least multiple manufacturing devices (18-22) are configured identically to one another. They are preferably designed as individual manufacturing cells (23). A different, e.g. multi-cell, design is possible as well. FIG. 3 shows an example of a cellular manufacturing device (18-22).

The depicted manufacturing device (18-22), in particular manufacturing cell (23), operates automatically. It comprises a single, preferably central working point (26) or a processing area and one or more application-flexible manufacturing means or manufacturing units (28, 29). There can alternatively be multiple working points (26) or processing areas. The working point(s) (26) can be used to sequentially receive at least two different or type-different LAM (6) and the respective workpiece (2, 2′, 2″) and/or tool (8) being carried along.

The manufacturing means (28, 29) can be designed to be the same or different, and can be provided singly or multiply. At least one manufacturing means (29) is used to process a workpiece (2, 2′, 2″) in the processing area (26), in particular on the LAM (6). The manufacturing means (29) can also handle a workpiece (2, 2′, 2″). Preferably, another different manufacturing means (28) is used for handling a workpiece (2, 2′, 2″).

The manufacturing means (28, 29) are, for example, distributed around the working point (26). They are in particular located on both sides of the working point (26) and the conveying path (7). The manufacturing means (28, 29) can be stationary or arranged to be movable by means of an additional axle. The application-flexible manufacturing means (28, 29) are preferably configured as multi-axis and programmable industrial robots and can pick up, use and, if necessary, automatically release and change the needed tool (8) or tool segment with the aid of an automatic change coupling. A manufacturing means (29) can alternatively be configured in a different manner, for example as a machine tool.

The application-flexible manufacturing means (28, 29) are preferably designed for a variety of tasks. The manufacturing means (29) comprise interchangeable application-specific tools (8), for example, for performing the respective manufacturing process. Said tools are, for example, configured as a joining tool, a forming tool or the like. These manufacturing means (29) are configured as welding robots, for example. The other manufacturing means (28) also hold interchangeable application-specific tools (8), which are, for example, configured for handling the one or more workpieces (2) during the manufacturing process. Said tools (8) can be gripping tools. The manufacturing means (28) are configured as handling robots, for example.

The manufacturing device (18-22), in particular the manufacturing cell (23), comprises one or more repositories (27) for the aforementioned tools (8). The manufacturing device (18-22) further comprises a control device with a storage means for a plurality of control programs, which are application-specific and adapted to different LAM types (A, B, C, D). The manufacturing device (18-22) also has a detection device for the type identifier. The manufacturing system (1) comprises a control that is connected to control units for the manufacturing devices (18-22), the conveying device (4) and the provisions (9, 10, 11).

The basic configuration of the manufacturing device (18-22), its manufacturing means (28, 29) and any other device components is application-neutral; to adapt them to the respective application, they are either fitted with application-specific tools (8) and reprogrammed, or a control program is used. This basic configuration and the fitting and adaptation options make said devices and means application flexible.

The manufacturing device (18-22), in particular the manufacturing cell (23), can further comprise one or more supply devices for operating means, in particular electric current, fluidic media or the like, as well as auxiliary devices. A surrounding protective enclosure (24), e.g. in the form of a fence, can be provided as well. One or more gates (25) for the protected entry and exit of a conveying means (5) with a LAM (6) on the conveying path (7) can be provided in the protective enclosure (24).

A conveying path (7) for a conveying means (5) with a LAM (6) for a workpiece (2, 2′, 2″) and/or for a tool (8), which extends through both the manufacturing device (18-22) and working point (26), is arranged in each manufacturing device (18-22) in the above-mentioned manner. As shown in FIGS. 3 to 5, at the working point (26), a storage carrier (62) for a workpiece (2, 2′, 2″) is arranged at a vertical distance from the conveying path (7). FIGS. 3 and 4 show a front view of two operating positions of the storage carrier (62). FIG. 5 depicts a side view of FIG. 3.

The storage carrier (62) is held rigidly or movably on the working point (26) by means of a local support device (59). The storage carrier (62) forms a temporary repository for a workpiece (2, 2′, 2″). Said storage carrier is preferably disposed at a vertical distance directly above the near-ground conveying path (7) and preferably also above the conveying means (5). In the case of an overhead conveyor, the arrangement can be carried out in a different manner, in particular reversed,

A passage opening (65) for a conveying means (5), which can either be empty or loaded with a workpiece (2, 2′, 2″), is configured between the conveying path (7) and the storage carrier (62).

The storage carrier (62), which is preferably configured to be mobile, can be moved between a working position on the conveying path (7) shown in FIG. 3 and a rest position a distance away from said working position as per FIG. 4. For this purpose, the manufacturing device (18-22) comprises a handling device (64). Said handling device can be configured as a separate, controllable and driven device. It can alternatively be formed by a programmable manufacturing means (28), in particular a handling robot.

As shown in FIGS. 3 and 4, in the working position, the storage carrier (62) can cover the passage opening (65) at the conveying path (7) from the top and, in the rest position, unblock it. This allows even an empty or loaded conveying means (5) with overheight to pass the working point (26) on the conveying path (7). The kinematics of the mobile storage carrier (62) can be configured in any suitable manner. Said kinematics can, for example, consist of the shown pivoting movement. A displacement movement is possible as well. The storage carrier (62) can also brought into a rest position with a very large vertical distance from the conveying path (7), and a correspondingly enlarged vertical clearance, by a handling device (64) disposed on the support device (59).

The storage carrier (62) is preferably configured in one piece and in plate or frame-like manner. Said storage carrier can alternatively have a multipart design, wherein the rest position is created by distancing the carrier parts from one another and changing their position and/or their form in a suitable manner, for example by folding them.

In the working position, the storage carrier (62) is preferably oriented to be lying down, in particular horizontally. Said storage carrier is preferably held stationary and supported. The working position or the working height can be tailored to the process requirements and the program-controlled manufacturing means (28, 29) and their work area.

In its function as a temporary repository, the storage carrier (62) can accommodate one or more workpieces (2, 2′, 2″). For this purpose, it comprises a controllable and driven clamping and positioning device (36), which is disposed on the upper side of the carrier, for example. The workpiece or workpieces (2, 2′, 2″) are preferably accommodated on the storage carrier (62) lying or standing.

The support device (59) is disposed locally at the working point (26). It is configured in a frame-like manner and is designed in such a way that, on the one hand, it leaves the conveying path (7) and the axial passage opening (65) open. On the other hand, it can also comprise one or more openings in the transverse direction for the same purpose. In the depicted design example, said support device comprises multiple supports (61), which are disposed laterally to the conveying path (7) and spaced apart from one another. Said supports can be fixedly or movably, in particular displaceably, disposed on the floor.

At the working point (26), the manufacturing device (18-22) comprises a positioning device (58) for a LAM (6) and/or for a conveying means (5). The positioning device (58) is preferably disposed on the support device (59).

In the depicted design example, the positioning device (58) acts mechanically on the LAM (6) and/or the conveying means (5). It comprises positioning means (60) on the supports (61), for example, which are disposed rigidly or, preferably movably, in particular in a height adjustable manner. The positioning means (60) can be configured as height-adjustable support arms, for example, that project transversely into the passage opening (65). They are preferably located in the lower part of the supports and position the LAM (6) in the work area of the program-controlled manufacturing means (28, 29). The positioning means (60) comprise index pins or index openings, for example, for the defined form-fitting accommodation of the LAM (6) and/or the conveying means (5). As a result of the height adjustability of the positioning device (58), a LAM (6), for example, can be released from the conveying means (5) and lifted off. The released or empty conveying means (5) can then leave the working point (26).

In other embodiment variants, a positioning device (58) can consist of markings in the area of the conveying path (7), which are detectable in a tactile or contact-free manner, can be detected by the conveying means (5) and provide for the program-controlled and self-propelled positioning of said conveying means. In another variant, stops which can be pivoted into the travel path can be used for the longitudinal and lateral positioning of the LAM (6) and/or the conveying means (5). In terms of control technology, a positioning device (58) can also be configured via the programmed control of the conveying means (5) and the integrated path measurement or navigation of said conveying means.

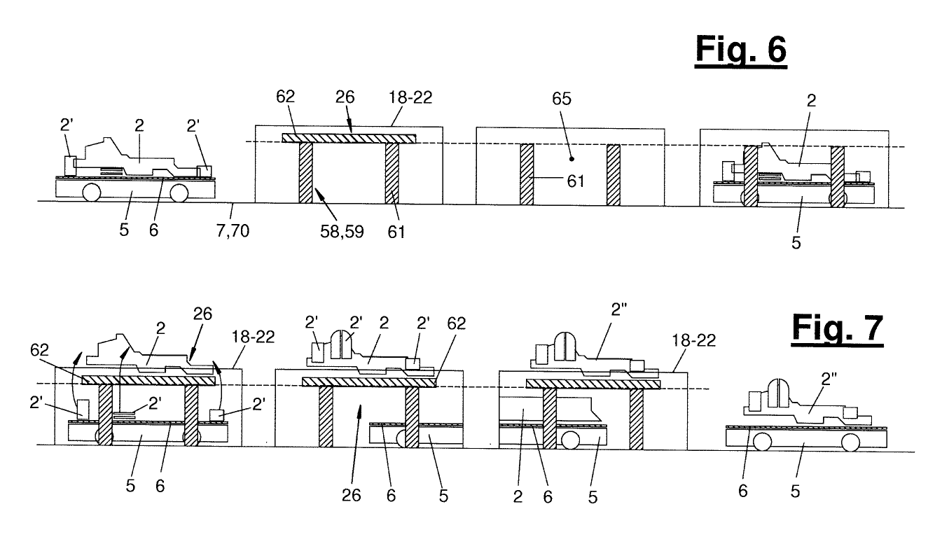

As shown in FIGS. 3 to 5 and in the functional sequences of FIGS. 6 and 7, at the working point (26), a workpiece (2, 2′, 2″) can be transferred from a LAM (6) to the storage carrier (62). This can be achieved with the aid of a program-controlled manufacturing means (28), in particular a handling robot, through the front-side and lateral openings of the support device (59). To unload a larger workpiece (2), for example as shown in FIG. 4, the mobile storage carrier (62) can temporarily be removed or moved into the rest position, and then moved back into the working position,

The workpiece or workpieces (2, 2′, 2″) can be disposed on the LAM (6) in a position and arrangement that is tightly packed and favorable for transport. They do not yet have to be in a manufacturing-appropriate position. This may, however, not be the case. In the design examples shown, the manufacturing-appropriate position and relative allocation of multiple workpieces (2, 2′) to one another on the storage carrier (62) is configured. In this case, the multiple workpieces (2, 2′) can, if necessary, be assembled and positioned and clamped in a process-appropriate manner by the clamping and positioning device (63). One or more program-controlled manufacturing means (28, 29) can subsequently perform one or more processes on the workpiece or workpieces (2, 2′).

As FIGS. 3 to 7 show, multiple workpieces (2, 2′), for example, are initially held in loose allocation on a LAM (6). They are then transferred to the storage carrier (62) and assembled, and subsequently joined. This ultimately results in a joined workpiece (2″) as per FIG. 7.

Once the LAM (6) is unloaded, the conveying means (5) can leave the working point (26) with the LAM (6) and clear the conveying path (7) for a subsequent conveying means (5). Said conveying means can deliver another one or more workpieces to the working point (26). Alternatively, the free conveying path (7) can also be used for the simple passage of an empty or loaded conveying means (5) through the respective manufacturing device (18-22). It is furthermore possible, in the aforementioned manner, to leave the LAM (6) on the positioning device (58) and allow the empty conveying means (5) to proceed.

After completion of the one or more manufacturing processes, the workpiece or workpieces, in particular the joined workpiece (2), can be loaded from the storage carrier (62) back onto an available conveying means (5) and a LAM (6). For this purpose, the storage carrier (62) can be moved back into the rest position, if necessary, and clear the access to the LAM (6) from above. Load transferring can also be accomplished with the aid of a program-controlled manufacturing means (29).

FIG. 6 shows a functional sequence upon entry of a loaded conveying means (5) into a working point (26). To do this, the storage carrier (62) is first moved from the working position into the rest position and the passage opening (65) is cleared from the top, so that the conveying means (5) with the LAM (6) and the workpiece or workpieces (2, 2′) can move into the working point (26) and the support device (59). The right picture of FIG. 6 shows this position. When the storage carrier (62) is open, the overheight workpiece (2) can then, as per FIG. 4, be removed, held and placed onto the storage carrier (62), which is back in the working position. The other workpiece or workpieces (2′) can subsequently be removed and assembled with the workpiece (2). The left picture of FIG. 7 shows this function step. The next two pictures show the exit of the unloaded conveying means (5) and the entry or passage of another conveying means (5). After the end of the process, the processed, in particular assembled and joined, workpiece (2) is loaded back onto a conveying means (5) with a LAM (6) and transported away.

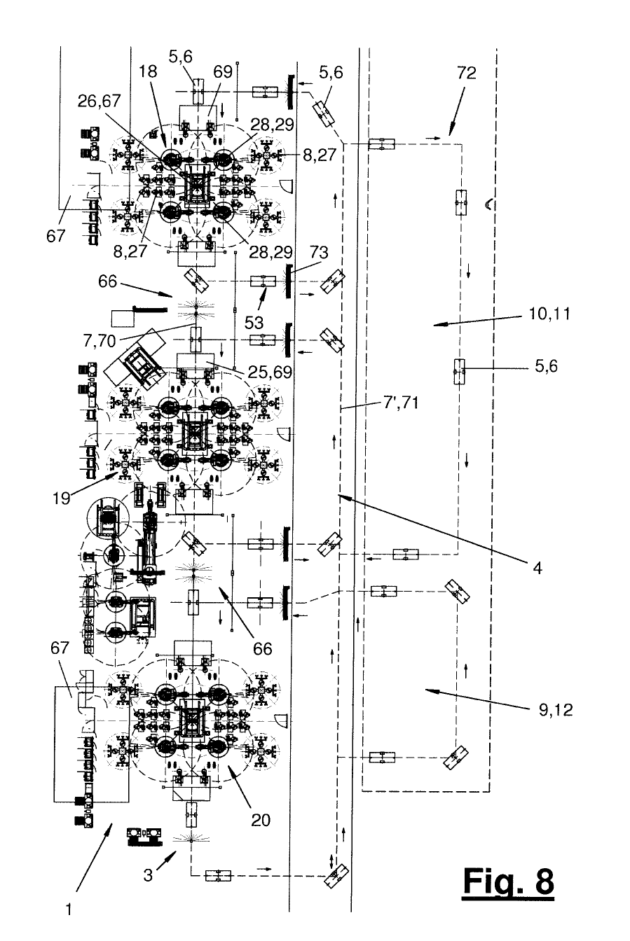

As shown in FIGS. 1 and 8, one or more application-flexible manufacturing devices (18-22) can be connected to another manufacturing device (67) for a secondary process on a workpiece (2, 2′, 2″). A multiple arrangement of such manufacturing devices (67) is possible as well. Said manufacturing devices can be arranged laterally adjacent to or also above or below a manufacturing device (18-22). One or more program-controlled manufacturing means, in particular industrial robots, for handling and processing the workpieces (2, 2′, 2″) as well as other devices, such as stationary welding tongs, stud guns, applicators for glue etc., can be disposed in a further manufacturing device (67).

The primary process(es) performed in an application-specific manufacturing station (18-22) are preferably geometry-specific to the mentioned manufacturing product. Such processes can consist of assembly and joining, for example. A joining process can consist of bonding (so-called preprocess) or geometry-determining spot welding or laser welding, or riveting or clinching or the like. The one or more secondary processes in a further manufacturing device (67) can be geometry-non-specific. They can, for example, include joining, measuring, shaping, cutting or the like. Joining can also include the attachment of additional parts, such as bolts or the like. Hard-coded secondary processes consisting, for example, of perforating, folding, drilling and/or milling or the like, are possible as well.

The workpiece change between the application-specific manufacturing device (18-22) or the one or more further manufacturing devices (67) can be effected via an interface (68) disposed, for example, at a throughway on a protective enclosure (24). The further manufacturing areas (67) can likewise be surrounded by a protective enclosure (24). The workpiece exchange can be performed by a program-controlled manufacturing means (28), in particular a handling robot.

Additional interfaces (69) can be disposed at the entrance and the preferably opposite exit of the manufacturing device (18-22) and can be formed by the gates (25), for example.

Modifications of the depicted and described design examples are possible in a variety of ways. The features of the various design examples and their variants can in particular be combined with one another as desired, notably also interchanged.

While the present invention has been illustrated by a description of various embodiments, and while these embodiments have been described in considerable detail, it is not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

1 manufacturing system
2 workpiece
2′ workpiece
2″ workpiece
3 manufacturing area
4 conveying device, Fleet
5 conveying means, AGV
6 load-receiving means LAM
7 conveying path
8 application-specific tool
9 provision for load-receiving means LAM
10 provision for workpieces, warehouse
11 provision for tools, tool store
12 provision for conveying means
13
14
15
16
17
18 manufacturing device
19 manufacturing device
20 manufacturing device
21 manufacturing device
22 manufacturing device
23 manufacturing cell, process cell primary
24 protective enclosure
25 gate
26 working point, processing area
27 repository, storage carousel
28 manufacturing means, robots, handling robots
29 manufacturing means, robots, welding robots
30
31
32
33
34
35
36
37
38
39
40
41
42
43
44
45
46
47
48 manufacturing loop, Type A
49 manufacturing loop Type B
50
51
52
53 parking area
54
55
56
57
58 positioning device LAM
59 support device
60 positioning device
61 support
62 storage carrier
63 clamping and positioning device
64 handling device
65 passage opening
66 access corridor
67 manufacturing device secondary process
68 interface
69 interface
70 conveying line, outward path
71 conveying line, return path
72 logistics area
73 safety gate, through-passage
A Type LAM
B Type LAM
C Type LAM
D Type LAM

What is claimed is:

1. Automatic manufacturing device (18-22) for workpieces (2, 2′, 2″), in particular for bodywork components, which comprises at least one program-controlled manufacturing means (28, 29) and a working point (26), characterized in that a conveying path (7) for a conveying means (5) having a load-receiving means (6) for a workpiece (2, 2′, 2″) and/or for a tool (8) is arranged in the manufacturing device (18-22), which path extends through the manufacturing device (18-22) and through the working point (26), wherein, at the working point (26), a storage carrier (62) for a workpiece (2, 2′, 2″) is arranged at a vertical distance from the conveying path (7).

2-39. (canceled)
